(19) United States
(12) Patent Application Publication
(10) Pub. No.: US 2002/0198979 A1
(43) Pub. Date: Dec. 26, 2002

(54) Weighted decay system and method

(76) Inventor: Allen Yu, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 09/880,341

(22) Filed: Jun. 13, 2001

(51) Int. Cl. G06F 15/16; G06F 15/173

(52) U.S. Cl. 709/224; 709/218

(57) ABSTRACT

A method for systematically calculating a weighted sum without the need for maintaining the value of each individual term by first providing a weighted sum equation that can be represented in recursive form; second, rewriting the weighted sum equation as a recursive equation; and third, applying the recursive equation to progressively update the weighted sum. The method may also include a method for tracking a user's activities in a web site and decreasing user activity counts that represent a user's previous activities. This method comprises the following steps. The first step is storing a previous user activity count in a database configured to track the user's activities in the web site. The next step is receiving a current user activity count derived from the user's current activities in the web site. Then a weighted reduction is applied to the previous user activity count to form a weighted activity count. Another step is combining the weighted activity count with the current user activity count to form an updated user activity count. A final step is replacing the previous user activity count in the database with the updated user activity count.

### FIELD OF THE INVENTION

The present invention relates generally to a method for weighted logging. In particular, it discloses an efficient method for keeping and systematically retiring time weighted logs.

### BACKGROUND

In today's highly competitive Internet environment, web sites need to be more than just mass publication pages if they want to attract and retain visitors. Successful websites need to be personalized and customized to meet individual users' interests and needs. Effective personalization should be automatically generated and content driven.

The foundation upon which successful, personalized websites are built is the accurate gathering of information related to user behavior and usage patterns. As an example for an e-commerce site, information about which products or product types users are most interested can prove invaluable to the conception of products and promotion of sales. The tracking of user behavior and usage patterns, however, introduces a problem that will be referred to here as the delayed latency problem.

Suppose a website is tracking user interest in two particular category groups: A and B. In addition, a significant number of user interests hits may be registered for category A at a specific time. After a while, user interest in category A may die out. Later in time, many user interest hits may be registered for the second category—category B. However, after interest in category B subsides, the total count of interests in category B is still slightly below that of category A.

If a promotion is to be based off the more popular of the two categories, should the promotion be based off category A or B? The answer is not straightforward. The promotion should be based off category B if the interests recorded for category A have become outdated. This is because so much time has elapsed since users have shown interest in category A that user's activity in category A has now become irrelevant. On the other hand, the promotion should be based off category A if activities recorded for both categories are still relevant and current—as in the case, perhaps, when categories are seasonal where fluctuation in interests is to be expected.

In the past, solutions that have been proposed to overcome this delayed latency problem are script based. After a set time interval, a script is run to clear or reduce the activity count. This solution requires high overhead because separate batch jobs must be created, maintained, and scheduled to run. A script-based solution is undesirable because it requires additional resources just to maintain the counts, and it is unnatural since the resultant count is dependent on the particular interval chosen for the scripts to run.

### SUMMARY OF THE INVENTION

A method for tracking a user's activities in a web site and decreasing user activity counts that represent a user's previous activities. The method comprises the following steps. The first step is storing a previous user activity count in a database configured to track the user's activities in the web site. The next step is receiving a current user activity count derived from the user's current activities in the web site. Then a weighted reduction is applied to the previous user activity count to form a weighted activity count. Another step is combining the weighted activity count with the current user activity count to form an updated user activity count. Finally, the method includes the step of replacing the previous user activity count in the database with the updated user activity count.

A method for determining a user's preferences for user activities in a web site by tracking a user's activities using user activity counts and aging the user activity counts for a user's previous activities in the web site. The method comprises the following steps. The initial step is storing an original user activity count in a database configured to track the user's activities in the web site. The next step is receiving a current user activity count derived from the user's activities in the web site. Another step is applying a time-weighted reduction to the previous user activity count to form a weighted activity count. Then the weighted activity count is combined with the current user activity count to create an updated user activity count. A final important step is identifying a preferred user activity based on the updated user activity count.

The invention provides a method for personalizing digital objects and content associated with a web page that is sent to users across a network. It also includes a method for systematically and efficiently retiring old personalization histories without the need to keep a running log of past activities.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a flow chart of the steps taken to generate a personalized web page with cached components;

FIG. 2 is a database entity and relationship diagram illustrating a database structure for a cache-enabled implicit personalization system;

FIG. 3 is a block diagram that illustrates the relationships between hierarchical categories, keywords and resources;

FIG. 4 is a database entity and relationship diagram illustrating a database structure for a personalized search engine system.

### DETAILED DESCRIPTION

For the purposes of promoting an understanding of the invention, references will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure are to be considered within the scope of the invention.

A solution to the delayed latency problem described above is a method that systematically decrements or retires interest activities given the amount of passage of time. One way to do this is to time weigh each interest count by an exponential factor of time. The exponential nature of the time weighting allows the time-weighted equation that sums up the interest activities to be written recursively. The recursive nature of the equation means that no running logs of the interest activities need to be kept, even as a time weighted sum of all interest activities is needed. The exponential nature of the time weighting allows the concept of a half life to be defined so that activity counts for the interest categories can be systematically retired.

Another general embodiment of the invention includes a method for tracking a user's activities in a web site and decreasing or aging user activity counts that represent a user's previous activities. This method includes a number of steps. The first step is storing a previous user activity count in a database configured to track the user's activities in the web site. This previous user activity count may be the user's initial count that is recorded for an activity or it may a previously weighted count. An activity is generally defined as accessing a resource, digital object or a link. The previous user activity may have occurred on the previous day or further back in time.

The next step is receiving a current user activity count derived from the user's current activities in the web site. This current activity count may the number of clicks a user has performed in a certain activity area. Once the values are obtained a weighted reduction is applied to the previous user activity count to form a weighted activity count. This weighted activity count is combined with the current user activity count to form an updated user activity count. The previous user activity count in the database is replaced with the updated user activity count. A final optional step is identifying a preferred user activity based on the updated user activity count.

The current invention discloses an efficient and accurate method of recording and retiring interest counts. It will be further discussed in relation to several embodiments. Although two of the embodiments are described under the context of implicit personalization, it should be understood that the method and system encompasses a more generic method. This method is for taking a series equation that can be rewritten or approximated (i.e., represented) in recursive form. The next step is redefining the equation in recursive form. Another step is applying the equation to progressively update and store the value of a weighted sum for any computer applications requiring a weighted sum to be calculated. Specifically, the method calculates a weighted sum without the need for maintaining the value of each individual term in a database. The current embodiments show the application of a one-dimensional (1-D) exponential equation in time that may be used in personalization related systems. In general, the idea presented in the current invention can be applied to any weighted phenomenon that can be reduced or approximated in recursive form. The embodiments should not be construed to limit the invention to 1-D, exponential, time based, or personalization related systems.

In general, an exponentially decaying function can be expressed as

ƒ(t)=ce −0.693t/τ Equation 1

where τ is the half life, and c is some constant.

The net contribution due to independent exponentially decaying processes can in general be written simply as a sum of the independent exponentially decaying functions,

i.e., y(t)=c₁e^{k·t}^{₁}+c₂e^{k·t}^{₂}+ . . . +cₙe^{k·t}^{ₙ} Equation 2

where k is some constant and can be conveniently set to be say (−0.693/τ) and tᵢ is the time interval between event i and the current time t. Assume, for the sake of the current discussion and without any loss of generality that the events are labeled in the order of occurrence, i.e. that t₁>t₂> . . . >tₙ. With this stipulation, the above expression can be interpreted to model the effects of a series of ordered events, whose effects decay in a uniform exponential fashion. The magnitude of each event is expressed by a constant cᵢ corresponding to each event. The rate of decay of the events is expressed through the constant k or the half-life parameter τ. Typically in order to calculate y(t), the cumulative effect of events 1 . . . n at time t, it is necessary to keep a record or log of each event (i.e., cᵢ and tᵢ and kᵢ—as expressed in Equation 2).

If Δtᵢ is defined as:

Δtᵢ=tᵢ−tᵢ₊₁ Equation 3

for i=1 . . . (n−1)

y(t) then can be re-written as

y(t)=c₁e^{k·(Δt}^{₁}^{+Δt}^{₂}^{+ . . . +Δt}^{ₙ₋₁}^{+t}^{ₙ})+c₂e^{k·(Δt}^{₂}^{+ . . . +Δt}^{ₙ₋₁}^{+t}^{ₙ}⁾+ . . . +cₙe^{k·(t}^{ₙ}⁾ Equation 4

Rearranging terms,

y(t)=((((c₁e^{k·Δt}^{₁}+c₂)e^{k·Δt}^{₂}+c₃)e^{k·Δt}^{₃} . . . +cₙ₋₁)e^{k·Δ}^{ₙ₋₁}+cₙ)e^{k·t}^{ₙ} Equation 5

Which can equivalently be written in a recursive form as

y(t)=zₙ(t)·e^{k·t}^{ₙ} Equation 6

where z is recursively defined, i.e.

zᵢ(t)=zᵢ₋e^{k·Δt}^{ᵢ₋₁}+cᵢ

for i=2 . . . n

z₁(t)=c₁ Equation 7

for i=1

The fact that y(t) can now be expressed recursively means that to calculate y(t), the system does not necessarily need to keep a running record or log of each independent event as a typical application using equation 2 would have suggested. Instead, the system can equivalently update a single activities count related to a series of events—i.e. zᵢ(t)—as each event takes place throughout time.

Here is an example of the application of equation 7. For the first event, the activity count z₁(t) is simply updated to be the activity effect of event 1 (i.e. cl ). With the occurrence of the second event, one updates the activity count at that time z₂(t) by adding the activity effect of event 2—(i.e. c₂) to the previous effect count z₁(t) where the previous activity effect count is weighted by an exponential z₁·e^{k·Δt}^{₁}. Activity counts after subsequent events can be similarly updated.

This invention may also be implemented in other computer systems where tracking a count of user's activities in selected areas is valuable and those counts should be weighted or retired over time. For example, an operating system may desire to display the programs a user runs most often over a period of time, an application may want to display only the functions that are most often used, or an automated address book may display addresses a user has been recently accessing. Three other exemplary embodiments will be presented in detail below to promote an understanding of the invention. The first embodiment involves a dynamic, personalized, marketing oriented web site. The second embodiment involves a dynamic, personalized, search engine. The third embodiment involves a dynamic, load-balancing router. Since the first two embodiments contain elements of personalization, a brief background on personalization will be discussed first.

Background on Personalization

There are two basic types of personalization: explicit and implicit personalization. In the first case, customization is driven by information the user has explicitly given. This includes the situation where a user fills out a survey and a website is customized based on the information given by the user. In the second case, personalization is driven implicitly by electronic observation or data collection about the user's behavior.

Explicit personalization requires a user to register and answer a survey to identify the user's interests. One shortcoming of this approach is that many people prefer to browse websites anonymously or do not want to register until they are ready to purchase. A second shortcoming of the registration approach is that even after a user has already registered, the user's interests may change.

Implicit personalization does not require a user to take proactive actions like filling out a survey. The user is implicitly tracked through their user ID and login or some other method of unique identification (e.g., a cookie). An implicit system only requires the web site or web server to track the areas that a user has visited. For example, if a user spends 60% of their time on the outdoor sports website in the tennis racquet section, he is probably a tennis player. The benefit of implicit personalization is that users need not be registered for it to work. In addition, users are not burdened with the responsibility to keep their profiles current. In either case, knowing that a visitor is a tennis player is invaluable when it comes to the personalization of content, such as promotions. Implicit personalization is the preferred type of personalization in most circumstances. The embodiments in this description will primarily focus on this second type of personalization.

In particular, the focus of the embodiments will be on “click-stream” personalization. In other words, personalization of digital objects provided to a user based on the electronic observation of user activity within a website (i.e., the sections of the website the customer visits, etc.). Digital objects are generally defined as web pages, executable scripts, graphic objects, sounds, video, documents, animations, executable objects, and similar objects which may be sent to a user from a web site. Although the concepts disclosed here are applied to HTML formatted web pages in the following embodiment, the concepts disclosed can apply equally to other types of electronic documents. These other documents include but are not limited to low resolution documents that are used with mobile and wireless devices such as PDA's, pagers, and mobile phones. In addition this invention may also be applied to audio documents that serve devices such as those used by the visually impaired and to hyper documents that serve the various virtual reality devices and Internet enabled appliances.

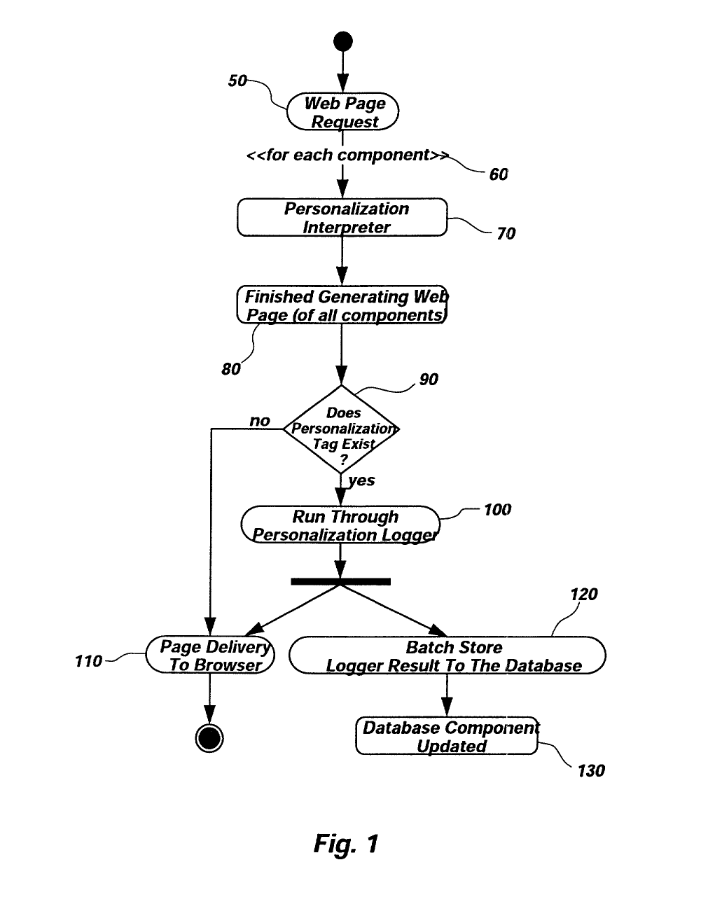

FIG. 1 is a flow chart of the steps needed to generate a personalized web page. The chart illustrates the context in which the system components interact and shows the logical flow of the system. The flow chart begins with a web page request 50 and shows the steps required for page delivery. A processing component in the flow chart refers to a software routine that results in the generation of HTML component. An HTML component is basically a library of HTML codes devised mainly for reuse and maintainability purposes. A typical HTML page may contain multiple HTML components.

Referring to FIG. 1, after a web page request is received, each of the page's components 60 need to be generated and later to be sent to the client for display. The generation of a personalized page requires a call to the personalization interpreter 70. The results returned from the personalization interpreter will dictate the particulars of the customizations that need to be done on a given page.

After page generation, the generation of components within the web page is complete 80. At this stage after page generation, but before page delivery, the system determines whether personalization tags exist in the web page to be delivered 90. If they do, the page and/or components are run through the personalization logger 100, which is responsible for implicitly logging and tracking the sections of a site the user has visited using the personalization tags. The personalization logger stores the user's activity in a database component 120. It is only after properly logging the user visit that the generated web page is finally sent to the user's browser for display 110. It is important to point out that the personalization interpreter customizes content during page generation, using information stored by the personalization logger.

It is relevant to note that due to the inherent costs associated with the generation and customization processes, a caching system is often implemented to facilitate the sharing of commonly viewed pages or components.

### Personalized Promotion Embodiment

In this first embodiment, a system for a personalized sports promotion system is introduced. This system will first determine the type of sport in which a user is most interested by implicit click-stream tracking. Once a sport type is determined, the system will promote the three most popular types of equipment from that sports category to the user. The system presented in the current embodiment consists of two main sub-components: a database component and a personalization component. The following sections describe each of these components in more detail.

### Database Component

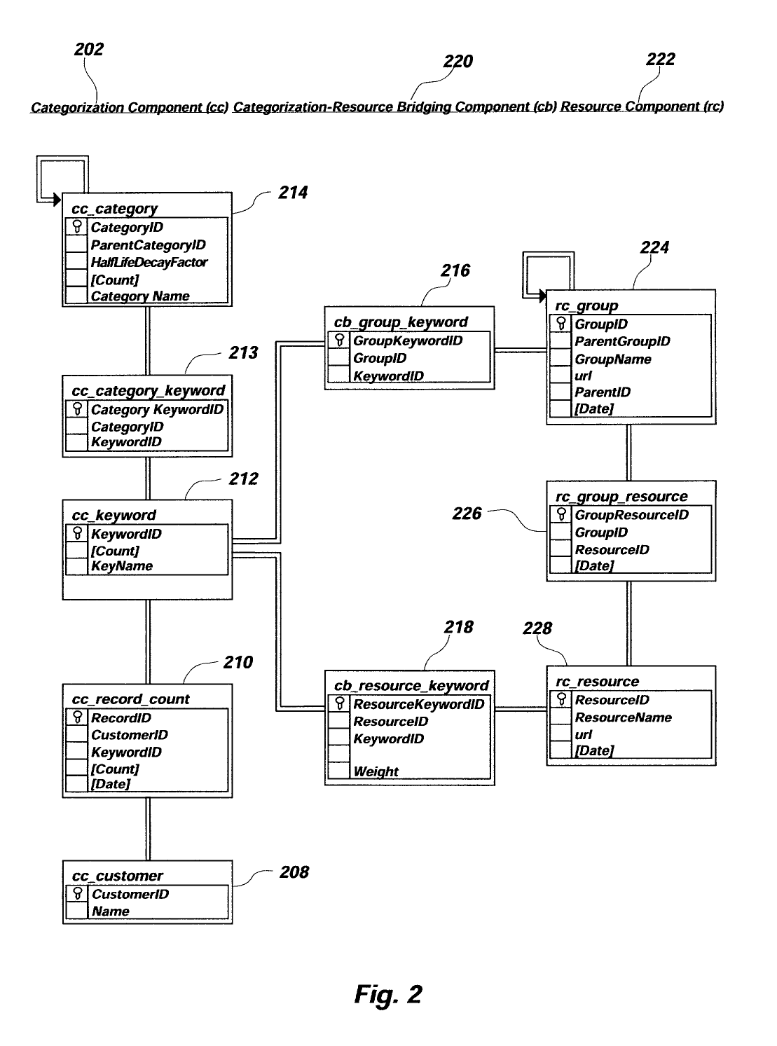

For the discussion of the database components, please refer to FIG. 2. The tables in the database schema are laid out in three columns, each of which corresponds to a database sub-component. In addition, the prefix of each table name identifies the component to which it belongs. For example, all tables in the first column belong to the categorization component and have a prefix of “cc_” in their name.

Referring to FIG. 2, the categorization component 202 forms the core database component of the personalization system and consists of at least six categorization tables. The categorization tables form the depository where customer behavior (e.g., click-stream tracking) is logged. The tracking takes place within the context of a nested tree of categories and keywords. The nested tree is provided by the cc_keyword 212 and cc_category 214 tables. A category can contain subcategories or keywords. Each page on a web site will be tagged with keywords defined here to identify the type or types of information presented on the page. The nested category—keyword tree structure defines the relationship among keywords. It is from this relationship that the personalization interpreter is able to personalization analysis needed for content personalization.

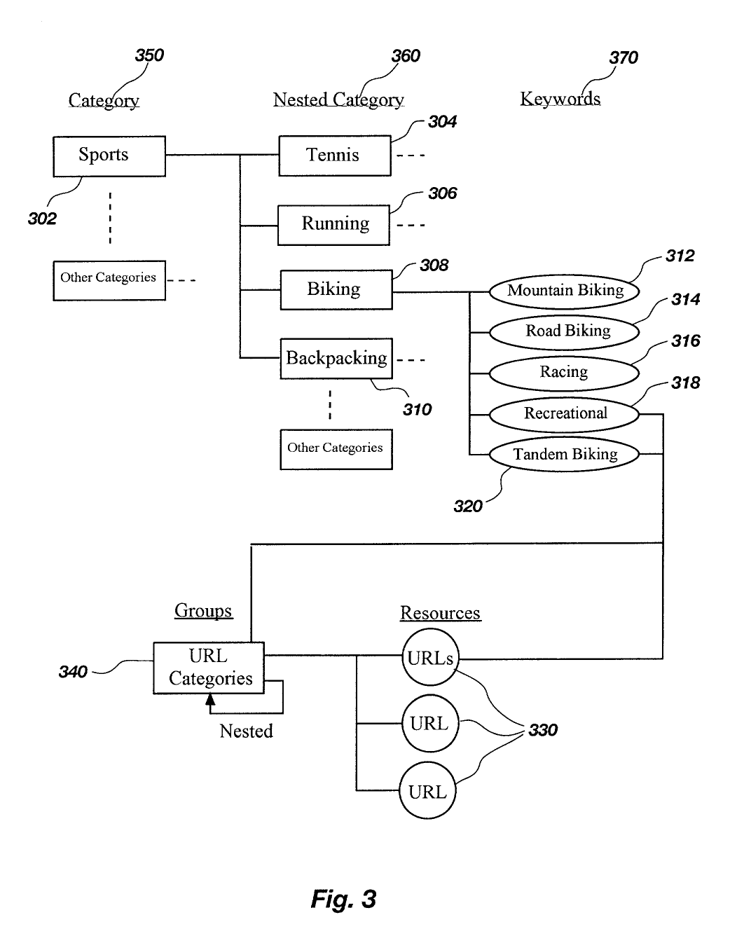

FIG. 3 illustrates a typical use of the personalization category schema presented above. The example of a sports category 302 is presented to contain the sub-categories: tennis 304, running 306, biking 308, and backpacking 310. The biking category, in turn, contains keywords such as mountain biking 312, road biking 314, racing 316, recreational 318, and tandem biking 320. It should be realized that the depth of the nested categories is not limited, but it can be any number of levels desired by the system designer or users.

The preferred embodiment of this invention only uses keywords at the lowest level of the hierarchy for a more uniform accounting of counts, but this invention may also use keywords associated with the parent categories or nested categories where appropriate. A personalization analysis may involve the inquiry for the most commonly viewed sport for a particular user, in which case, any of the sub categories of sport tennis, running, biking, and backpacking can be returned.

FIG. 3 provides an overview of the details of the system for personalizing digital objects and content associated with a web page. The personalization system includes content categories 350 that are nested hierarchically 360 and are linked to a plurality of keywords 370. Resources 330 are also associated with a plurality of keywords. The personalization system tracks each user's activities by storing an activity level for keywords associated with each resource. This allows the users' activities to be tracked as the user accesses the resources or URLs. A user's content preferences are determined based on the activity level recorded for the relevant keywords across multiple categories. When the personalization system has determined the user's content preferences, digital objects associated with a web page are delivered to users based on the user's content preferences across multiple categories. The following two examples serve as concrete examples for the use of the hierarchical categorization scheme just described.

Referring back to FIG. 2, while the cc keyword 212, cc_category_keyword 213, and cc_category 214 tables described above provide a framework to record customer behavior, the actual recording of the user's view count is stored in the cc_record_count table 210. All of a user's view counts are stored in the context of both the customer ID (or user ID) from the cc_customer table 208 and the keyword ID. Accordingly, the activity associated with keywords is stored in a count representing the number of times a resource was accessed. For example, if a user views a web page tagged with a keyword referring to mountain bikes, a count is recorded that is keyed to both that keyword and the user's ID. This way the system has a separate count of each keyword activity for every user or customer. The personalization system can also store a user activity level representing time or some other user activity metric.

The other two components of the database are the category-resource bridging and the resource components. The resource component basically forms a generic, hierarchical structuring system similar to Yahoo or directory tree structure categories. The category-resource bridging component basically allows each resource or categories of resources to be associated with a set of personalization keywords. Referring again to FIG. 2, the cb_group_keyword 216 and the cb_resource_keyword tables 218 are used to provide a scheme where items, web pages, components, or digital objects on a website can be tagged with multiple keywords which allows components to be categorized in multiple categories. The categorization-resource bridging component also provides different weightings for associations between resources and keywords

### Personalization Component (Logger and Interpreter)

A logging component on the web server is responsible for updating the count in the database for each personalization keyword or tag found on a web page. Logging or the recording of user interests occurs after page generation (the generation or retrieval of the digital object to be delivered—i.e. an HTML page) and before page delivery or transmission of a digital object), as described in the flow chart of FIG. 1. In addition to updating the count in the database, the personalization component strips out the personalization tag before allowing the generated page to be sent to a users browser. One major advantage of the personalization component in the present system is the implementation of a weighted recording system for multiple categorizations.

The interpreter component consists of a library of routines to implement commonly used personalization queries. The following list shows the base functions on which more complicated queries can be built.

get_sorted_result(category)→keyword or category list

get_sorted_keywords(category)→keywords or nothing

get_sorted_categories(category)→categories or nothing

get_max(keyword or category list)→keyword or category

get_min(keyword or category list)→keyword or category

### Application of the Current Invention to the Personalization System

One of the main problems with all personalization systems is the delayed latency problem. For example, suppose a user of the system was originally most interested in mountain biking but the user has since moved on to road biking. Because the user has been a mountain biker for years, it may take years of browsing before the activity counts for a newly found road biking interest can overtake the counts for the user's prior mountain biking interests. In the interim, the biker will continue to get personalized mountain bike information instead of personalized road bike information. Worse still, by the time the personalization systems catches up to the user's new road biking interest, the user might have moved on to another sport like tennis. Now the user has both the mountain biking and road biking history to surmount before a personalization system can catch up to his tennis interests. A solution to overcome this problem involves the integration of a weighted decay system.

One embodiment for implementing a weighted decay system is to use an exponential decay method, where the most recent activity has the highest value and older activity quickly declines in value. In the preferred embodiment of this system, exponential decay is defined as the process by which earlier counts are slowly retired or decremented over time. The purpose of this is to allow a user to change interests without having their previous preferences outweigh their present preferences.

Exponential decay solves these delayed latency problems. Each time a count is updated, the old count may be multiplied by a factor e^{(-0.693t/τ)}, where τ is the number (in days) given by the HalfLifeDecayFactor field in the cc_category table 214, and t (again in days) equals the current date minus the Date field of the cc_record_count table in days 210. The HalfLifeDecayFactor (in the database) defines the period over which the count decreases by half. For example, with a HalfLifeDecayFactor of 180 days, counts from half a year ago will be halved while counts from 1 year ago will be reduced by ¾ or multiplied by (1-½*½), and so on. Exponential decay ensures that old records are retired in a systematic and reliable fashion so new interests can be quickly registered and used for personalization.

The count is recorded in a manner that incorporates a weighted decay over time. Note that in this specific embodiment, no running log of the activity count is required. In fact, the count is updated each time a new count is recorded such that the older count is continually decremented with time. The decay system outlined above is a direct application of Equation 6 and Equation 7. Note the elegance of the solution. The older the user's activity is, the less weight it will be given in the system. The time decrement is executed continually (with every count updates) and systematically. Furthermore, this weighting is done without requiring a running log of user activities to be kept.

### Personalized Search Engine Embodiment

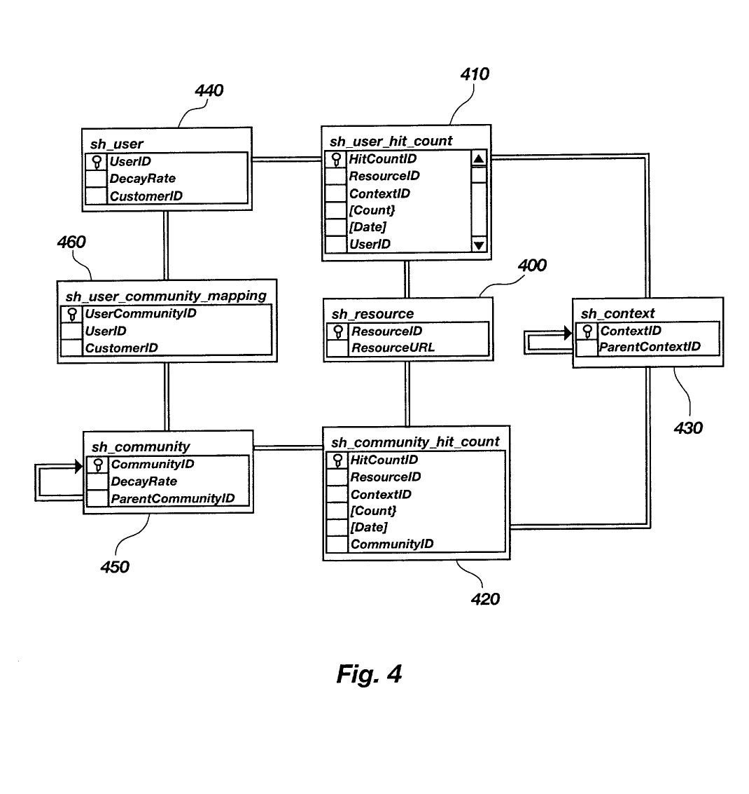

Another embodiment involves a personalized search engine system. FIG. 4 shows the data modeling associated with the system. When a user 440 submits a search request, a generic list of search results is returned. A resource 400 in the data model refers to an item on this search result list. Once a user clicks on a result item, a count is recorded to indicate user interest for that item. There are two ways in which the recording of user interests can be done. The interest counts can be recorded on a per user basis 410 and/or a per community basis. A community 450 is a group of users that a user may join 460. In this current discussion, the focus will be on community based interest activity. The relevant table where this community count will be recorded is the sh_community_hit_count table 420.

Each time a user clicks on a result item a count will be recorded with respect to the community (or communities) to which the user belongs, the resource in which the user is interested, and a search context 430. A search context is basically an ID associated with a set of search patterns. For example, a user may search for network printers by typing either “networked printers” or “network printer,” but in either case, the user is searching for the same things so both searches should be associated under the same context. The recording of interest counts will be done relative to this context and not to the exact search words typed.

The present invention can also be used with a personalized search engine. Suppose a community called “network administrators” has been formed. By tracking the items that users belonging to this community are interested in, the search engine can present a sorted list ordered by relevancy to the community. This is a different type of personalization than in the previous embodiment. The primary difference is that personalization in the previous embodiment is done on a per user basis while personalization in the current embodiment is done for an aggregated user group. In this search application, such personalization gives the users the ability to categorize information on the web site or Internet based on the relevancy of that information to the community as a whole.

As in the first embodiment, the problem of delayed latency exists in this second embodiment. Suppose the “network administrators” community has created a log of interests in dot matrix printers during the eighties a log of interests in ink jet printers in the nineties, but the interest counts registered for ink jet printers have not managed to surpass that of dot matrix printers. Unfortunately, users would continue to be presented with results that presume that dot matrix printers are the most popular even though it has been a decade or more since they were widely used. As a result, it is necessary to provide a system to retire those dot matrix printer counts in a systematic way.

The delayed latency problem associated with the personalized search engine embodiment can be solved with the current invention in a similar way that the problem in the first embodiment is solved. In this case, the rate of decay is defined on a per community basis (see the DecayRate field in the sh_community table). The count and the date fields in the sh_community_hit_count table (similar to the cc_record_count table in the previous embodiment) are then updated with the application of Equation 6 and Equation 7.

Another embodiment of the present invention unrelated to personalization will now be discussed. This embodiment of the current invention involves a load balancing redirector. Load balancing redirectors are router type devices that are used in redirecting incoming network request traffic when the traffic reaches a server cluster. Load balancing distributes traffic to specific servers within the cluster to more evenly divide work among the servers and to enhance the overall cluster performance. One commonly used load balancing redirector uses a round robin scheme where incoming requests are passed in a predetermined serial, “round robin” fashion to each server within the cluster in turn. A more efficient way to distribute the workload is to base the routing decision on the length of request service times polled from each server, or in other words how long it takes each server to complete a requested service.

The problem encountered with this approach is the uncertainty of the number of request service times that need to be considered for a reliable estimate of server load. Any single request service time is an unreliable indicator server load. Conversely, the entirety of all request service times ever logged cannot be considered reliable either because such a log contains old, expired data. The solution is to create a time weighted request service times average where the more recent service request times are weighted more heavily than the older ones. In other words, an activity level or count is stored for each member or server of the system and then it may be weighted. This is valuable because request service time may vary over time based on the cluster conditions. The current invention can be used for calculating just such a time-weighted average. It can do so without the need to keep a running log, and it allows the weighting (decay rate) to be adjusted to suit the particular needs and environments of the system (e.g. number of servers per cluster, number of average concurrent users, etc.).

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention with respect to current technologies and state of art, it will be apparent to those of ordinary skill in the art that numerous modifications, including, but not limited to, form, function and manner of operation, implementation and use may be made, without departing from the principles and concepts of the invention as set forth in the claims.

What is claimed is:

1. A method for tracking a user's activities in a web site and decreasing user activity counts that represent a user's previous activities, comprising the steps of:
(a) storing a previous user activity count in a database configured to track the user's activities in the web site;
(b) receiving a current user activity count derived from the user's current activities in the web site;
(c) applying a weighted reduction to the previous user activity count to form a weighted activity count;
(d) combining the weighted activity count with the current user activity count to form an updated user activity count; and
(e) replacing the previous user activity count in the database with the updated user activity count.

2. A method as in claim 1 wherein the step of applying a weighted reduction further comprises the step of applying a time weighted function to decrease the previous user activity count.

3. A method as in claim 1 wherein the step of applying a weighted reduction further comprises the step of applying a time weighted exponential function to decrease the previous user activity count.

4. A method as in claim 1 wherein the step of applying a weighted reduction further comprises the step of applying the function
$$f ( t ) = c {ⅇ}^{\frac{- .693 t}{τ}}$$
to the previous user activity count,
where
τ is the half life;
c is the previous user activity count; and
t is a time interval since the original user's activity count was last updated.

5. A method as in claim 1 further comprising the step of repeating steps (b) through (e) for each current user activity count that is received.

6. A method for determining a user's preferences for user activities in a web site by tracking a user's activities using user activity counts and aging the user activity counts for a user's previous activities in the web site, comprising the steps of:
(a) storing an original user activity count in a database configured to track the user's activities in the web site;
(b) receiving a current user activity count derived from the user's activities in the web site;
(c) applying a time weighted reduction to the previous user activity count to form a weighted activity count;
(d) combining the weighted activity count with the current user activity count to create an updated user activity count; and
(e) identifying a preferred user activity based on the updated user activity count.

7. A method as in claim 6 wherein the step of applying the time weighted reduction further comprises the step of applying a time weighted exponential function to decrease the previous user activity count.

8. A method as in claim 6 wherein the step of applying a time weighted reduction further comprises the step of applying the function
$$f ( t ) = c {ⅇ}^{\frac{- .693 t}{τ}}$$
to the previous user activity count,
where
τ is the half life;
c is the current user activity count; and
t is a time interval since the original user's activity count was last updated.

9. A method as in claim 1 further comprising the step of repeating steps (b) through (d) for each current user activity count that is received.

10. A method for personalizing digital objects and content associated with a web page sent to a user across a network, comprising the steps of:
(a) accessing hierarchical categories that include a plurality of keywords connected to the categories;
(b) associating a plurality of resources with the keywords, wherein the resources refer to digital objects;
(c) recording activity levels for keywords associated with resources accessed by the user;
(d) weighting the activity levels recorded for the keywords based on a user's activity which has occurred; and
(e) delivering digital objects to the user based on the weighted activity levels for a plurality of keywords.

11. A method as in claim 10, wherein step (d) further comprises the step of weighting the activity levels associated with the keywords based on a date user activity occurred.

12. A method as in claim 10, wherein step (d) further comprises the step of weighting the activity levels associated with the keywords based on a length of time the digital object is used.

13. A method as in claim 10, wherein the step of weighting the activity associated with the keywords further comprises the step of tracking the activity of the user by storing a count representing the number of times each resource is accessed.

14. A method as in claim 13, further comprising the step of decreasing the count as an amount of time increases after the user's activity took place.

15. A method as in claim 13, further comprising the step of exponentially decreasing the count as an amount of time since the user's activity took place increases.

16. A method as in claim 13, further comprising the step of exponentially decreasing the count as an amount of time since the user's activity took place increases using a factor e^{(-0.693t/τ)}.

17. A method as in claim 10, further comprising the step of capturing the user's activity by recording universal resource locators (URLs) clicked on by the user.

18. An article of manufacture, comprising:
a computer usable medium having computer readable program code means embodied therein for personalizing digital objects and content associated with a web page sent to a user across a network:
computer readable program code means for accessing hierarchical categories that include a plurality of keywords connected to the categories;
computer readable program code means for associating a plurality of resources with the keywords, wherein the resources refer to digital objects;
computer readable program code means for recording activity levels for keywords associated with resources accessed by the user; and
computer readable program code means for weighting the activity levels recorded for the keywords based on a user's activity which has occurred; and
computer readable program code means for delivering digital objects to the user based on the weighted activity levels for a plurality of keywords.

19. A method for programmatically calculating a weighted sum without the need for maintaining the value of each individual term, comprising the steps of:
(a) providing a weighted sum equation that can be represented in recursive form;
(b) redefining the weighted sum equation to produce a recursive equation; and
(c) applying the recursive equation to progressively update the weighted sum.

20. A method as in claim 19 wherein the step of applying the recursive equation further comprises the step of applying a time weighted function to decrease the previous system activity count.

21. A method as in claim 19 wherein the step of applying the recursive equation further comprises the step of applying a time weighted exponential function to decrease the previous system activity count.

22. A method for tracking a computer system's activities and decreasing values that represent a computer system's previous activities, comprising the steps of:
(a) storing a previous system activity level in a database configured to track the computer system's activities;
(b) receiving a current system activity level derived from the computer system's current activities;
(c) applying a weighted reduction to the previous system activity level to form a weighted system activity level;
(d) combining the weighted system activity level with the current system activity level to form an updated system activity level; and
(e) replacing the previous system activity level in the database with the updated system activity level.

23. A method as in claim 22 wherein the step of applying a weighted reduction further comprises the step of applying a time weighted function to decrease the previous system activity level.

24. A method as in claim 22 wherein the step of applying a weighted reduction further comprises the step of applying a time weighted exponential function to decrease the previous system activity level.
